(19) United States
(12) Patent Application Publication
(10) Pub. No.: US 2014/0320536 A1
(43) Pub. Date: Oct. 30, 2014

(54) Methods and Systems for Determining Orientation of a Display of Content on a Device

(71) Applicants: Vinson Mok, Sunnyvale, CA (US); Juan Vasquez, San Jose, CA (US)

(72) Inventors: Vinson Mok, Sunnyvale, CA (US); Juan Vasquez, San Jose, CA (US)

(73) Assignee: GOOGLE INC., Mountain View, CA (US)

(21) Appl. No.: 13/356,703

(22) Filed: Jan. 24, 2012

(51) Int. Cl. G06T 3/60

(52) U.S. Cl. 345/659

(57) ABSTRACT

Methods and systems for device orientation are described. A display of content on a device may be re-orientated when a device orientation changes. A font of a text or an aspect ratio of a picture displayed on the device may be changed when a device orientation changes to provide a user with an enhanced view. Re-orientation of display of content may not always be desirable. When the device is resting on a horizontal surface or the user is riding in a car, an orientation sensor in the device may trigger the device to re-orientate the display of content without the user desiring or initiating the re-orientation. Within examples herein, re-orientating the display of content on the device when a change in a contact with a perimeter of the device is determined may provide an enhanced experience to the user and may provide optimal device power utilization.

### BACKGROUND

Many portable devices, such as mobile phones and tablets, have display screens for interaction with a user. Some display screens are touchscreens—display screens responsive to touch commands from the user. Some of portable devices may be rectangular, oblong, circular, or oval in shape, and may have an orientation sensor and/or multiple sensors that allow the device to detect if the device's orientation has changed (e.g., between a portrait orientation and landscape orientation). Example sensors include gyroscopes, accelerometers, tilt sensors, or electronic compasses.

When a portable device detects, based on information provided by the orientation sensors, that its orientation has changed (e.g., rotated 90° counter-clockwise), the device may rotate or re-orientate and adjust the aspect ratio of what is currently displayed at the display screen of the device. In some instances, a user may prefer to hold the device in portrait orientation or may prefer landscape orientation. For example, if the user is reading text displayed at the display screen in portrait orientation, the user may rotate the device to cause the portable device to output the text in landscape orientation. In such instances, this automatic adjustment in aspect ratio (i.e., from portrait to landscape display orientation) may allow the user to view the displayed text at a larger size.

### SUMMARY

The present application discloses systems and methods for determining orientation of a content output at a display of a computing device (such as a mobile computing device). In one aspect, a method is provided that comprises receiving information associated with a change in a contact with a perimeter of a device. Based on the information associated with the change in the contact with the perimeter of the device, the method may also comprise receiving information associated with an orientation of the device. Based on the information associated with the orientation of the device, the method may further comprise determining that the orientation of the device has changed. The method may further comprise outputting, at a display operatively coupled to the device, content oriented based on the orientation of the device.

In another aspect, a non-transitory computer readable medium having stored thereon instructions executable by a computing device to cause the computing device to perform functions is described. The computing device may receive information associated with a change in a contact with a perimeter of a device. Based on the information associated with the change in the contact with the perimeter of the device, the computing device may also receive information associated with an orientation of the device. Based on the information associated with the orientation of the device, the computing device may also determine that the orientation of the device has changed. The computing device may further output, at a display operatively coupled to the device, content oriented based on the orientation of the device.

In still another aspect, a device is described. The device may comprise a processor, a display, and a memory. The memory may store instructions to cause the processor to receive information associated with a change in a contact with a perimeter of the device. Based on the information associated with the change in the contact with the perimeter of the device, the instructions may also cause the processor to receive information associated with an orientation of the device. Based on the information associated with the orientation of the device, the instructions may also cause the processor to determine that the orientation of the device has changed. The instructions may further cause the processor to output, at the display, content oriented in accordance with the orientation of the device.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a block diagram illustrating an example device, in accordance with at least some embodiments described herein.

FIG. 2 is a block diagram illustrating an example method for determining whether to change or maintain an orientation of a display of content on a device.

FIGS. 3A-3B illustrate example contact with a portable device in portrait orientation and landscape orientation.

FIG. 4 illustrates an example device with sensory elements to detect a change in a contact with a perimeter of the device, in accordance with at least some embodiments described herein.

FIGS. 5A-5B illustrate an example device with display of content on the device in portrait and landscape orientations.

FIG. 6 is a block diagram illustrating an example method for determining whether to change or maintain an orientation of a display of content on a device with optimal power utilization.

FIG. 7 is a functional block diagram illustrating an example computing device used in a computing system that is arranged in accordance with at least some embodiments described herein.

FIG. 8 is a schematic illustrating a conceptual partial view of an example computer program product that includes a computer program for executing a computer process on a computing device, arranged according to at least some embodiments presented herein.

### DETAILED DESCRIPTION

The following detailed description describes various features and functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

This disclosure may disclose systems and methods for device orientation. A display of content on a device may be re-orientated when the device orientation changes. A font of a text or an aspect ratio of a picture a display of content on the device may be changed when a device orientation changes to provide a user with an enhanced view. Re-orientation of the display of content on the device may not always be desirable. When the device is resting on a horizontal surface or the user is riding in a car, an orientation sensor in the device may trigger the device to re-orientate the display of content without the user desiring or initiating the display of content re-orientation. Within examples herein, re-orientating the display of content on the device when a change in a contact with a perimeter of the device is determined may provide an enhanced experience to the user and may provide optimal device power utilization.

In one example, orientation of a display of content on a device may change when a change in a contact with a perimeter of the device is detected. If a change in the contact with the perimeter of the device is detected, then a change in an orientation of the device may be determined through receiving information from a sensor associated with the orientation of the device. If a change in the device orientation is detected, then the orientation of the display of content may be changed and an aspect ratio adjusted.

### I. Device Orientation System

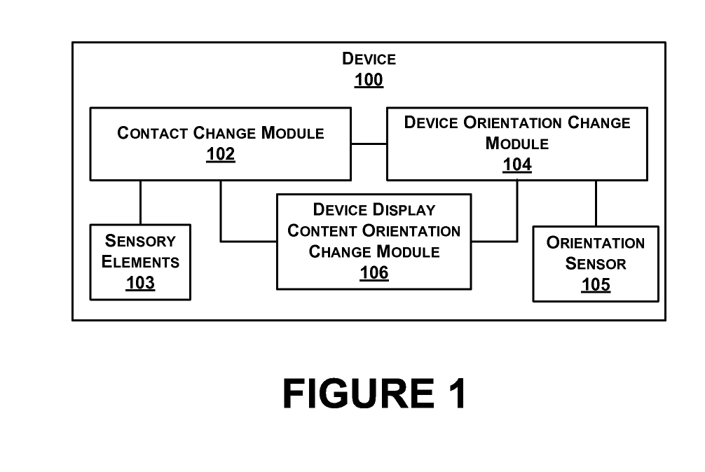

FIG. 1 is a block diagram illustrating an example device 100. The device 100 includes a contact change module 102, a device orientation change module 104, and a device display content orientation change module 106. In some embodiments, the device 100 can be, for example, a mobile phone, personal digital assistant (PDA), laptop, notebook, or netbook computer, tablet computing device, etc.

The contact change module 102 may be configured to determine a change in a contact with a perimeter of the device 100. In one example, the device 100 may have a frame or housing. The device 100 may also be a handheld device (e.g., a mobile phone). A change in hand placement, contact points, or grip on the frame or the housing of the mobile phone may be detected by the contact change module 102 through sensory elements 103 coupled to the frame of the device 100. The sensory elements 103 may include capacitive sensing elements, for example. A capacitance associated with the frame of the device may be measured through the sensory elements 103. A change in the contact with the device or a change in how the device is being held may be determined by detecting a change in the capacitance associated with the frame of the device.

Based on determining and/or in response to a change in the contact with the perimeter of the device 100, the device orientation change module 104 may be configured to receive information associated with a change in a device orientation from an orientation sensor 105 (e.g., a gyroscope or an accelerometer). The device orientation change module 104 may determine that a change in the device orientation has occurred. For example, the device 100 may be substantially rectangular in shape and the device orientation change module 104 may determine that the device orientation has changed from portrait orientation to landscape orientation with respect to a given frame of reference (e.g., a user viewpoint). Determining a change in device orientation may comprise a calculation based on the information received from the orientation sensor 105. For example, if the orientation sensor 105 is a gyroscope, determining a change in device orientation may comprise calculation of angles and rates of yaw, pitch, and roll of the device based on the gyroscope detecting 3-axis angular accelerations around X, Y, and Z axes.

Based on determining and/or in response to a change in the device orientation, the device display content orientation module 106 may be configured to re-orientate a display of content on a device or maintain orientation of the display of content. For example, the device display content orientation module 106 may change an orientation of a display of content on the device from portrait to landscape or change an aspect ratio of what is being displayed.

One or more of the described functions or components of the device 100 may be divided up into additional functional or physical components, or combined into fewer functional or physical components. In some further examples, additional functional and/or physical components may be added to the examples illustrated by FIG. 1. Still further, any of the contact change module 102, the device orientation change module 104, and/or the device display content orientation change 106 may include or be provided in the form of a processor (e.g., a microprocessor, a digital signal processor (DSP), etc.) configured to execute program code including one or more instructions for implementing logical functions described herein. The device 100 may further include any type of computer readable medium (non-transitory medium), for example, such as a storage device including a disk or hard drive, to store the program code. In other examples, the device 100 may be included within other systems.

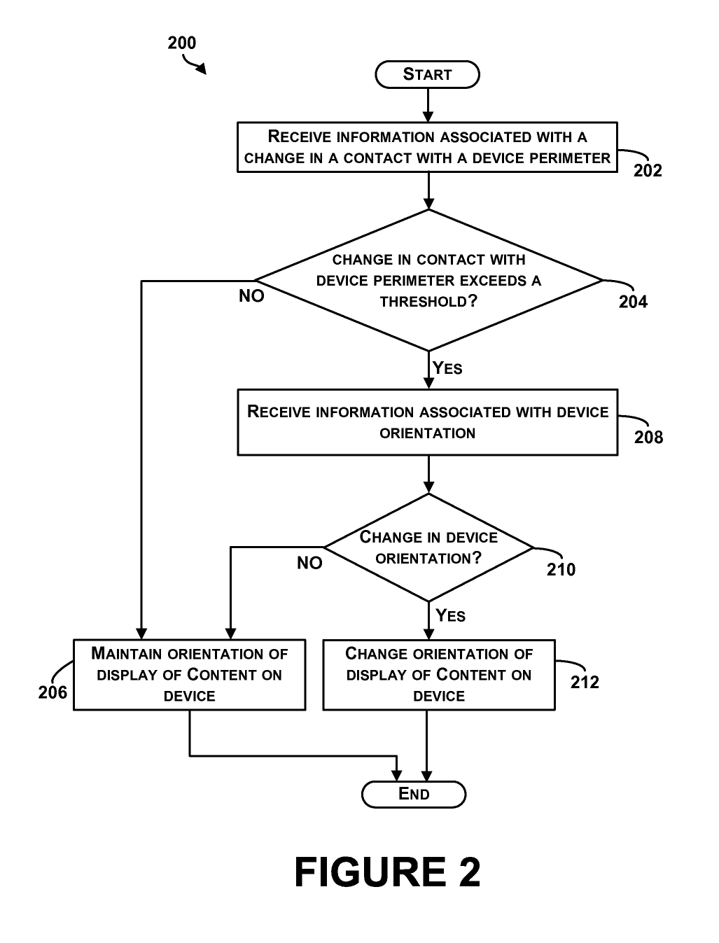

FIG. 2 is a block diagram of an example method 200 for determining whether to change or maintain an orientation of a display of content on a device. Method 200 may include one or more operations, functions, or actions as illustrated by one or more of blocks 202, 204, 206, 208, 210, and 212. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation

In addition, for the method 200 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 200 and other processes and methods disclosed herein, each block in FIG. 2 may represent circuitry that is wired to perform the specific logical functions in the process.

At block 202, method 200 includes receive information associated with a change in a contact with a device perimeter. For example, a device (e.g., a mobile phone or a computing device) may include a processor and the processor may be configured to receive signals from sensors monitoring change in the contact with the device perimeter. The device may be a hand held device. A change in a contact with a perimeter of the device may comprise a change in how the device is being held. For example, the device may comprise a frame. A capacitance associated with the frame of the device may be measured. A change in the contact with the device or a change in how the device is being held may be indicated by a change in the capacitance associated with the frame of the device. The change in capacitance may be less than or greater than a predetermined threshold depending on the change in how the device is being held.

At decision block 204, method 200 includes determining whether a change in contact with the device perimeter has exceeded a threshold. For example, a user may change hand placement, contact points, or grip on the frame of the device. If a change in a capacitance associated with the frame of the device or in other sensed parameters due to the change in hand placement, contact points, or grip exceeds a predetermined threshold, then the change in contact with the device perimeter may be deemed to have occurred.

At block 206, method 200 includes maintain orientation of a display of content on a device if no change or no substantial change in the contact with the perimeter of the device is detected. For example, if a user does not substantially change hand placement, contact points, or grip on the device, a change in a capacitance associated with the frame of the device or in other sensed parameters may not exceed a predetermined threshold. In this case, the change in contact with the device perimeter may not have occurred or may not be substantial. The orientation of the display of content on the device may be maintained and the method 200 terminates.

At block 208, method 200 includes receive information associated with device orientation if a change in contact with the device perimeter has been determined to exceed the predetermined threshold. For example, the device may include types of sensors that can provide information associated with the device orientation (e.g., gyroscopes, accelerometers, tilt sensors, or electronic compasses). Receiving information associated with device orientation may comprise receiving a signal from one or more of these types of sensors. In another example, a device orientation sensor may be turned off until a change in the contact with the perimeter of the device has been determined. Receiving information associated with the change in device orientation may comprise enabling the device orientation sensor and then receiving a sensor signal associated with the device orientation.

At decision block 210, method 200 includes determining if a change in device orientation has occurred. Determining a change in device orientation at block 210 may comprise a calculation based on the information received from an orientation sensor. For example, if the orientation sensor is a gyroscope, determining a change in device orientation may comprise calculation of angles and rates of yaw, pitch, and roll of the device based on the gyroscope detecting 3-axis angular accelerations around X, Y, and Z axes. If no change in the device orientation is detected, an orientation of a display of content on the device may be maintained at block 206.

At block 212, method 200 includes change orientation of a display of content on the device if a change in the contact with the perimeter of the device has occurred and a change in device orientation is detected. Changing the orientation of the display of content on the device may comprise a calculation to change an aspect ratio of what is being displayed on the device and/or to render what is being displayed in a different orientation with respect to a given frame of reference.

### II. Change in a Contact with a Perimeter of a Device

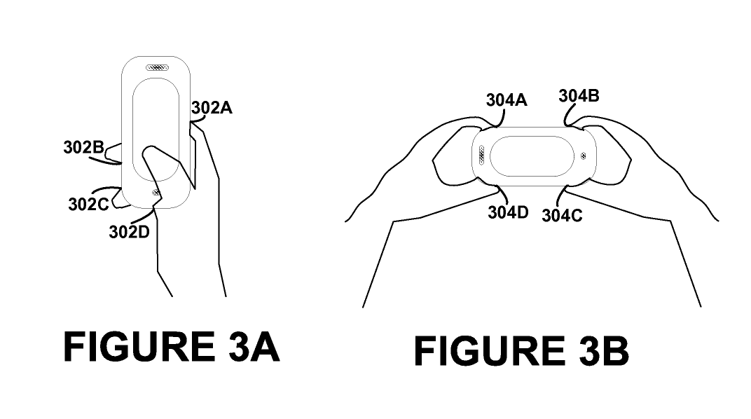

There may be several ways to detect a change in a contact with a perimeter of a device. In one example, the device may have a frame. The device may also be a hand held device (e.g., a mobile phone). FIGS. 3A-3B illustrate example contact with a portable device in portrait orientation and landscape orientation. Specifically, FIG. 3A illustrates a user holding a mobile phone in portrait orientation with contact points 302A-D, while FIG. 3B illustrates a user holding a mobile phone in landscape orientation with contact points 304A-D. A difference in hand placement, contact points (i.e., 302A-D and 304 A-D), or grip on the frame of the mobile phone in FIGS. 3A and 3B can be detected by several methods.

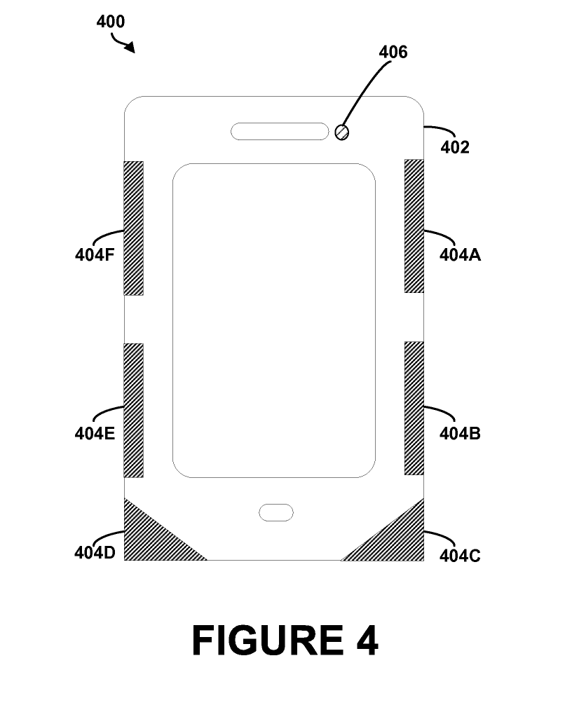

FIG. 4 illustrates a device 400 including a perimeter 402 with sensory elements 404A-F and 406 to detect a change in a contact with the perimeter 402 of the device 400, in accordance with at least some embodiments described herein. Sensing elements 404A-F and 406 are illustrated at various locations around the perimeter 402 and a surface of the device 400. These locations are for illustration only. For example, FIG. 4 illustrates the perimeter 402 of the device 400 divided into multiple sensing zones. In other embodiments, the entire or substantially entire perimeter 402 may be a single sensing zone with sensing elements 404A-F embedded in or coupled to the perimeter 402. Sensing elements 404A-F may include capacitive sensing elements, resistive sensing elements, pressure sensing elements, or tactile sensing elements. Sensing element 406 in FIG. 4 may be a proximity sensor, such as a photo diode or an ambient light sensor. The location of the sensing element 406 shown in FIG. 4 is for illustration only. The location can be changed to anywhere on a surface or a perimeter 402 of the device 400.

In one example, capacitance associated with the frame of the device may be measured. A capacitance change exceeding a predetermined threshold may indicate that a user holding the device changed hand placement, contact points, or grip on the frame of the device, and may trigger receiving information associated with an orientation of the device.

In another example, the frame may include capacitive buttons that can be touched by the user and a change in a contact with a perimeter or frame of a device may comprise a change in touching these buttons. A change may be detected by sensing a change in hand or fingers sliding contact with the frame.

Capacitance measurement may relate to a capacitive transducer that senses changes in the capacitive charge of a variable capacitor. This may be referred to as capacitive sensing. Capacitance may be a function of contact with a device frame. A frame may be configured to provide capacitive sensing by embedding a printed circuit board (PCB) behind or within the frame. Capacitive elements may be laid out on the PCB in the form of copper pads. There may be a small capacitance between these pads and a grounded mesh on the PCB that surrounds the pads. When a user presses or touches these capacitive pads, there may be an increase in the capacitance between the copper pad and ground. The increase is due to the electrically conductive nature of a human finger.

In other examples, resistive sensing may be used instead or in combination with capacitive sensing. Resistance associated with the frame of the device may be measured. A perimeter of the device may be made of electrically conductive material. A change in a contact with the frame may directly or indirectly change electrical resistance of a resistive element embedded in or included in the frame.

There are several types of resistive sensing elements. In one example, a thermistor, which includes a temperature sensitive device, may be used. Resistance of an element changes with a change in temperature. A change in contact with the perimeter of the device may cause a temperature change or a thermal distribution change that may cause a resistance change.

Another type of a resistive sensing element may include light-dependent resistors or photoresistors. Photoresistors react to light and may change resistance when exposure to light changes.

Yet another type of resistive sensing elements may include piezoresistive elements. Piezoresistive elements are made of a material that experiences a change in electrical conductivity and resistance when the material is elongated or compressed due to any mechanical input. For example, a change in a contact with a perimeter of a device may comprise a change in a mechanical input (e.g., compression) on the perimeter of the device. If the perimeter of the device includes piezoresistive elements, a change in conductive behavior or resistance of the piezoresistive elements may indicate a change in the contact with the perimeter of the device.

In still other examples, a change in a contact with a perimeter of a device may further be detected by measuring a change in grip pressure. Pressure sensors can be distributed in different locations around the perimeter and outer surface of the device to capture any change in grip pressure. There are different types of pressure sensors that may be used for the purpose of detecting a change in a grip pressure on the device. Piezoresistive elements can be used to measure a change in the grip pressure on the device. The piezoresistive element may produce a signal associated with the grip pressure applied to the device.

Anisotropic conductive film may be another type of pressure sensor that conducts electricity between upper and lower metals by pressure. Another example for a pressure sensor may include a device formed of a dielectric material having a restoration force, such as silicon, for measuring capacitive variation caused by a pressure-incurred change in the distance between an upper and a lower metal. There may be many other pressure sensing techniques that can detect a change in the grip pressure on the device.

In still other examples, a tactile sensor may be used to measure parameters of a contact between the sensor and an object. This interaction obtained may be confined to a small defined region. Tactile sensing may be defined as the detection and measurement of a spatial distribution of forces perpendicular to a predetermined sensory area, and the subsequent interpretation of the spatial information. A tactile sensing array may be considered as a coordinated group of touch sensors. A tactile sensor may be able to detect movement of an object (e.g., a human finger) relative to the tactile sensor.

A tactile sensor may include an array of touch sensitive locations; the locations may be capable of measuring more than one property. Contact forces for example, may be measured by a tactile sensor. The tactile sensor may be able to convey information about the state of a grip. Texture, slip, impact and other contact conditions generate force and position signatures that can be sensed by a tactile sensor. A tactile sensor may be a single-point contact; though the sensory area can be any size. The tactile sensing array may be capable of determining in real time, the magnitude, location, orientation of forces at a contact point.

An array of tactile sensors may be included in or coupled to a perimeter or a frame of a device. A change in a contact with a perimeter of a device may be detected by the array of tactile sensors. Changes in the contact with the perimeter of the device may result in changes in forces applied to the frame of the device at different locations on the frame. A tactile sensing array distributed on the perimeter may be able to detect such a change.

There are different types of tactile sensors. One type of a tactile sensor may be a mechanically based sensor. A force is applied to a conventional mechanical micro-switch to form a binary touch sensor. The force required to operate a switch will be determined by the actuating characteristics of the switch and any external constraints. Other approaches are based on a mechanical movement activating a secondary device such as a potentiometer or displacement transducer.

Another type of a tactile sensor, which is a resistance based sensor, includes the use of materials that have defined force-resistance characteristics. This type of sensor includes the measurement of a resistance of a conductive elastomer or foam between two points. The sensor may use an elastomer that consists of a carbon doped rubber. The resistance of the elastomer changes with the application of force, resulting from the deformation of the elastomer altering the particle density. If the resistance measurement is taken between opposing surfaces of the elastomer, the upper contacts may be made using a flexible PCB to allow for movement under the applied force. Sensors based on resistive sensing described in section B may be a subset of resistance based tactile sensors.

Another type of a tactile sensor, which is a force based sensor, includes a piezoresistive conductive polymer that changes resistance in a predictable manner following application of force to a surface of the sensor. The sensor may be supplied as a polymer sheet which may have a sensing film. The sensing film includes both electrically conducting and non-conducting particles. Applying a force to the surface of the sensing film causes particles to touch conducting electrodes, changing a resistance of the sensing film.

Yet another type of a tactile sensor, which is a capacitance based sensor, relies on the applied force either changing a distance between plates or an effective surface area of a capacitor. In such a sensor two conductive plates of the sensor may be separated by a dielectric medium, which may also be used as an elastomer that gives force-to-capacitance characteristics to the sensor.

Another type of a tactile sensor relies on magnetic transduction. A movement of a small magnet by an applied force may cause a flux density at a point of measurement to change. The flux measurement can be made by either a Hall Effect or a magnetoresistive device. Magnetic characteristics of a magnetoresistive or magnetoelastic material are modified when the material is subjected to changes in externally applied physical forces. A core of an inductor can be made from a magnetoelastic material that may deform under pressure and cause an inductance of a coil to change.

Another type of a tactile sensor is based on a strain gauge attached to a surface to detect a change in length of a material as it is subjected to external forces. The strain gauge may be made from either resistive elements (foil, or wire) or from semiconducting material. A resistive gauge may comprise a resistive grid being bonded to an epoxy backing film. A semi-conducting strain gauge may be made from a suitable doped piece of silicone. In this case, the mechanism used for a resistance change is a piezoresistive effect. When used as a tactile sensor, the strain gauge may be used as a load cell, where the stress is measured directly at the point of contact.

In other examples, a proximity sensing element may be embedded in a perimeter of a device or on a surface of a device to detect an imminent change in a contact with the perimeter of the device. For example, referring to FIG. 3, when a user changes the way the user holds a mobile phone from portrait to landscape orientation or vice versa, a proximity sensor may detect the change or transition that indicate a change in the contact with the perimeter of the device. A proximity sensor may detect a change or get activated when an object passes within a predetermined distance from the proximity sensor.

Proximity sensing may be implemented with a wire sensor or a long PCB trace connected instead of a capacitive pad, which was explained in the capacitive sensing section A. In another example, a photo diode or an ambient light sensor may be used as a proximity sensor. An ambient light sensor may detect changes in ambient light availability and brightness. A change in a contact with a perimeter of a device may cause a change in light availability to the device. A photo diode or an ambient light sensor may detect such a change in light availability and determine that a change in the contact with the perimeter of the device has occurred.

### III. Change in a Device Orientation

Several devices have capability to determine an orientation of the devices through sensors, such as accelerometers and gyroscopes. A gyroscope may detect 3-axis angular acceleration around X, Y, and Z axes, enabling precise calculation of angles and rates of yaw, pitch, and roll of the device. A device may also have an accelerometer, which detects acceleration, shake, and vibration shock by detecting linear acceleration along one of the three axes (X, Y, and Z). Combined data from the accelerometer and the gyroscope may provide detailed and precise information about the 6-axis movement in space of the device. The 3 axes of the gyroscope combined with the 3 axes of the accelerometer may enable the device to recognize approximately how far, fast, and in which direction the device has moved in space. Some devices that have cameras also may use tilt sensors to detect tilt for auto display re-orientation and to correct for shake when taking a picture, for example.

A device with an accelerometer, and/or a gyroscope, and/or tilt sensor can detect changes in a device orientation. For example, if a device is held in landscape orientation and is turned to portrait orientation, a gyroscope may detect rolling motion, or the tilt sensor may detect tilting the device. A processor in the device may receive signals from one or more sensors and determine that the orientation of the device has changed. The processor may be continuously receiving signals from the sensors and performing calculations to determine if the orientation of the device has changed or the sensors may be turned off until a change in a contact with a perimeter of the device is detected. Then, the sensor may be powered or enabled. When the sensor is enabled, orientation of a device may be determined. The device may be in transition from one orientation to another with respect to a given frame of reference. Device orientation calculations may be performed during the transition after the sensor has been enabled to determine that a change in the device orientation has occurred.

### IV. Change in an Orientation of a Display of Content on a Device

If a change in a contact with a perimeter of a device is detected, and if a change in an orientation of the device is detected (e.g., 90° rotation counter clockwise of the device relative to a given frame of reference), the device may re-orientate a display of content on the device. Reorientation may include changing orientation of a content displayed on the device with respect to a given frame of reference (e.g., to correspond with a viewpoint of a user). The content may include text, symbols, numbers, pictures, or videos.

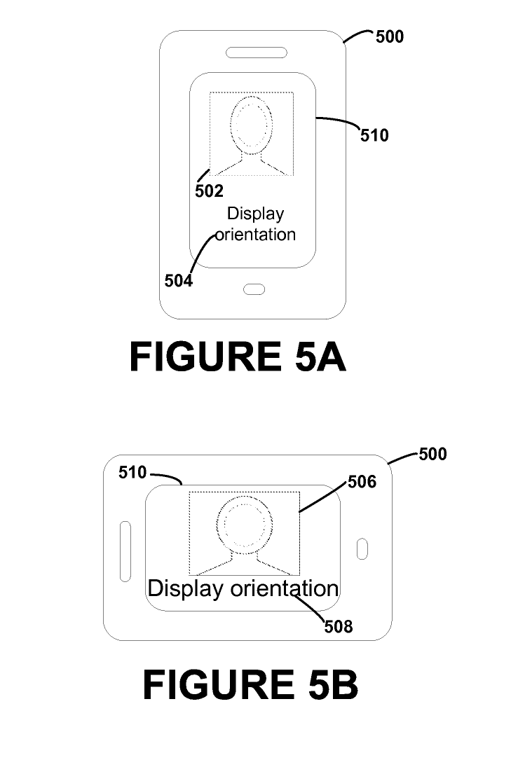

FIGS. 5A-5B illustrate a device 500 with a display of content in portrait and landscape orientations. FIGS. 5A-5B illustrate the device 500 having a display 510. In FIG. 5A, the device is shown in portrait orientation. A display of content on the device may include a picture 502 and a text 504. FIG. 5B shows the device 500 rotated 90° counter clockwise to landscape orientation. The device 500 may re-orientate the picture and text. Also, to make use of an increased horizontal space in landscape orientation, the device 500 may increase the font of the text and change an aspect ratio of the picture as shown in FIG. 5B. Picture 506 and text 508 show a change in picture aspect ratio and font size, respectively. If the device orientation is reversed back from landscape orientation to portrait orientation by rotating the device 90° clockwise, resizing the text and the aspect ratio of the picture may be reversed.

Resizing a content of display may be desirable by a user. For example, if the user is reading an article and the words appear small on the screen in portrait orientation, the user may rotate the device to landscape orientation and an adjustment in font size and aspect ratio allows the user to view larger words. Reorientation may include changing a character size while maintaining a certain scale (i.e., horizontal/vertical proportionality), or alternatively, an aspect size of a character may be altered while simultaneously altering the aspect ratio of the character. For example, a letter may be stretched so as to appear taller or wider than normal.

In another example, a user may be watching a video. Rotating the device to landscape orientation and the adjustment in aspect ratio of the video may enhance viewing the video. In general, reorientation and readjustment of display of a content may seek to improve readability or viewing experience of the content. Users may have different preferences. A device may allow users to make different choice and select their preferences related to re-orientating a display on the device.

### V. Example Power Utilization

Reorientation and readjustment may comprise a processor in a device performing mathematical computations. Computations performed to re-orientate a content of a display consume electric power. Optimizing power utilization may be desirable for a battery powered device. A device may be in a pocket of a user, resting on a horizontal surface, or may be hand held while a user is riding a car or moving. In these instances for example, reorientation of the content of the display on the device may not be desired, yet reorientation may occur without a user initiating or desiring the reorientation. Reorientation may occur because, for example, a moving car or a moving user, while the device is in the pocket of the user, may cause a change in a signal of a gyroscope or accelerometer or another orientation sensor in the device. The device may initiate reorientation of the content of the display mistakenly interpreting the change in the signal of the orientation sensor as an intentional change in the device orientation. Reorientation of the content of the display may be considered wasteful of electric power (e.g., battery power) when reorientation is not initiated or desired by a user.

According to the example in FIG. 2, a change in a signal of an orientation sensor may not cause or initiate reorientation of a content of a display unless a change in a contact with a perimeter of the device occurs as well. For example, if a device is in a pocket of user, the device may continuously be receiving information associated with the device orientation from an orientation sensor (e.g., an accelerometer). The device may also be continuously performing calculations based on signals from the sensor to determine if the device orientation has changed. However, the device may not initiate reorientation of the content of the display because the change in the contact with the perimeter of the device has not occurred. Avoiding computations of reorientation of the content of the display may save battery power.

Furthermore, to provide optimal power utilization, instead of continuously receiving information associated with the device orientation from an orientation sensor, the device may receive the orientation sensor signal when a change in a contact with a perimeter of the device occurs. The orientation sensor may be turned off until the change in the contact with the perimeter of the device has occurred. Referring back to block 202 in FIG. 2, receiving information associated with a device orientation may comprise enabling or activating a sensor that has thus far been turned off, and then performing device orientation calculation to determine if a change in device orientation has occurred.

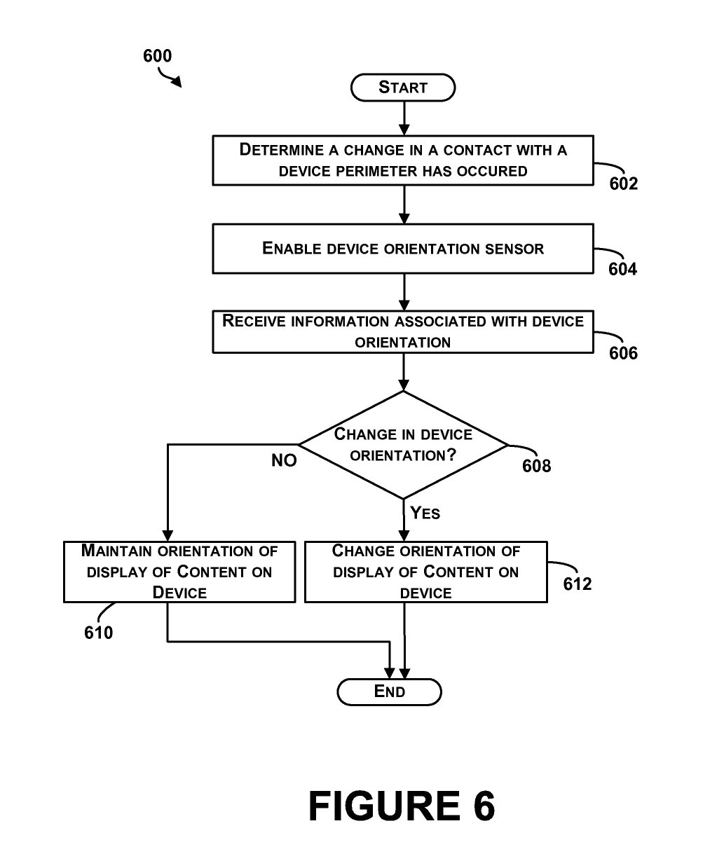

FIG. 6 is a block diagram illustrating an example method for determining whether to change or maintain an orientation of a display of content on a device with example optimal power utilization. Method 600 may include one or more operations, functions, or actions as illustrated by one or more of blocks 602, 604, 606, 608, 610, and 612. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation

In addition, for the method 600 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 600 and other processes and methods disclosed herein, each block in FIG. 6 may represent circuitry that is wired to perform the specific logical functions in the process.

At block 602, method 600 includes determine a change in a contact with a device perimeter has occurred. For example, the device may be a hand held device (e.g., a mobile phone). Determining a change in a contact with a perimeter of the device may comprise detecting a change in how the device is being held. For example, the device may comprise a frame. A capacitance associated with the frame of the device may be measured. A change in the contact with the device or a change in how the device is being held may be determined by detecting a change in the capacitance associated with the frame of the device exceeding a predetermined threshold.

At block 604, method 600 includes enable device orientation sensor. A device orientation sensor may have been turned off to save power until a change in the contact with the device perimeter is determined. Then, the device orientation sensor is powered or enabled when the change in the contact with the device perimeter occurs.

At block 606, method 600 includes receive information associated with device orientation. For example, the device orientation sensor may have been enabled and turned on at block 604. The device may then receive signals from the enabled sensor (e.g., gyroscopes, accelerometers, tilt sensors, or electronic compasses) that convey information associated with the device orientation.

At decision block 608, method 600 includes determining if a change in device orientation has occurred. Determining a change in device orientation at block 608 may comprise a calculation based on the information received from an orientation sensor. For example, if the orientation sensor is a gyroscope, determining a change in device orientation may comprise calculation of angles and rates of yaw, pitch, and roll of the device based on the gyroscope detecting 3-axis angular accelerations around X, Y, and Z axes.

At block 610, method 600 includes maintain orientation of display of content on the device. If no change in the device orientation occurred, orientation of a display of content on the device may be maintained. For example, if angles and rates of yaw, pitch, and roll of the device received from a gyroscope do not exceed a predetermined threshold, then a change in the device orientation may not have occurred. The orientation of the display of content on the device may be maintained and the method 600 terminates

At block 612, method 600 includes change orientation of display of content on the device. If a change in device orientation is determined at block 608, the device may be configured to change the orientation of the display of content on the device. Changing the orientation of the display of content may comprise a calculation to change an aspect ratio of what is being displayed on the device and/or to render what is being displayed in a different orientation with respect to a given frame of reference.

Method 600 may provide optimal power utilization, since the device may not receive signals from the orientation sensor, calculate device orientation, or perform re-orientation calculations of the display of content unless the change in the contact with the device perimeter occurs.

In other examples, a device may have mechanical buttons or locking switches that allow the user to disable a feature of reorientation of display of content. In yet another example, the user may disable the feature of reorientation of display of content by going through a software interface with menu options.

### VI. Example Systems and Computer Program Products

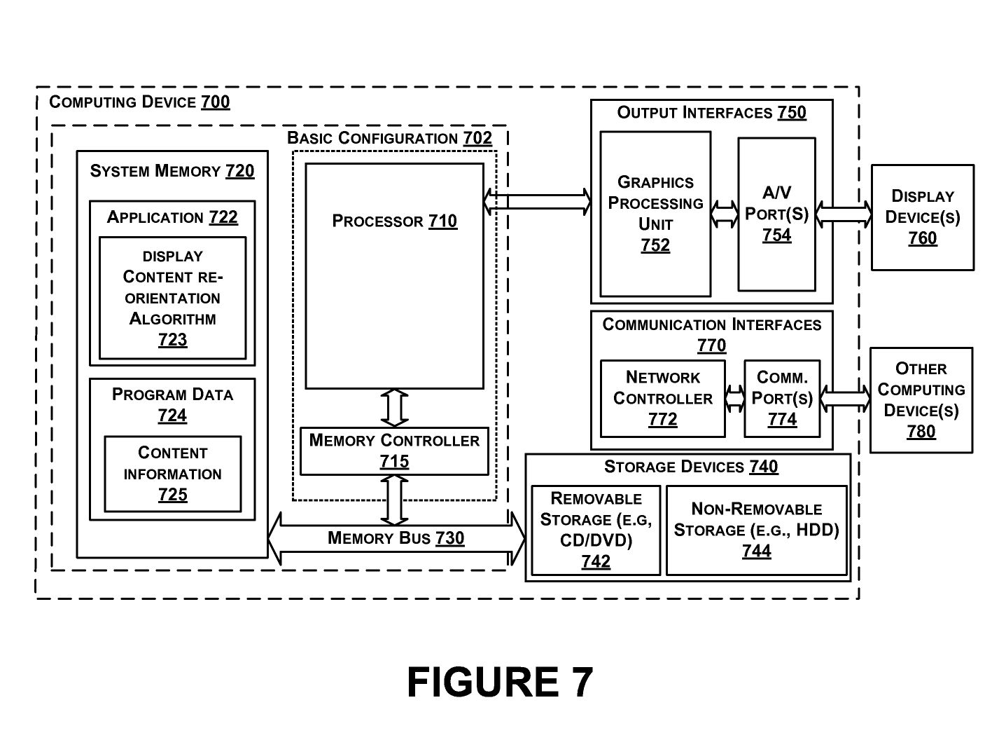

FIG. 7 is a functional block diagram illustrating an example computing device 700 used in a computing system that is arranged in accordance with at least some embodiments described herein. The computing device may be a personal computer, mobile device, cellular phone, video game system, or global positioning system, and may be implemented as a client device, a server, a system, a combination thereof, or as a portion of components described in FIGS. 1-2. In a basic configuration 702, computing device 700 may include one or more processors 710 and system memory 720. A memory bus 730 can be used for communicating between the processor 710 and the system memory 720. Depending on the desired configuration, processor 710 can be of any type including but not limited to a microprocessor (μP), a microcontroller (μC), a digital signal processor (DSP), or any combination thereof. A memory controller 715 can also be used with the processor 710, or in some implementations, the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 may include one or more applications 722, and program data 724. Application 722 may include display of content re-orientation algorithm 723 that is arranged to provide inputs to the electronic circuits, in accordance with the present disclosure. Program Data 724 may include content information 725 that could be directed to any number of types of data. In some example embodiments, application 722 can be arranged to operate with program data 724 on an operating system.

Computing device 700 can have additional features or functionality, and additional interfaces to facilitate communications between the basic configuration 702 and any devices and interfaces. For example, data storage devices 740 can be provided including removable storage devices 742, non-removable storage devices 744, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Computer storage media can include volatile and nonvolatile, non-transitory, removable and non-removable media implemented in any method or technology for storage of information, such as computer readable instructions, data structures, program modules, or other data.

System memory 720 and storage devices 740 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include output interfaces 750 that may include a graphics processing unit 752, which can be configured to communicate to various external devices such as display devices 760 or speakers via one or more A/V ports 754 or a communication interface 770. The communication interface 770 may include a network controller 772, which can be arranged to facilitate communications with one or more other computing devices 780 over a network communication via one or more communication ports 774. The communication connection is one example of a communication media. Communication media may be embodied by computer readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media.

Computing device 700 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 can also be implemented as a personal computer including both laptop computer and non-laptop computer configurations.

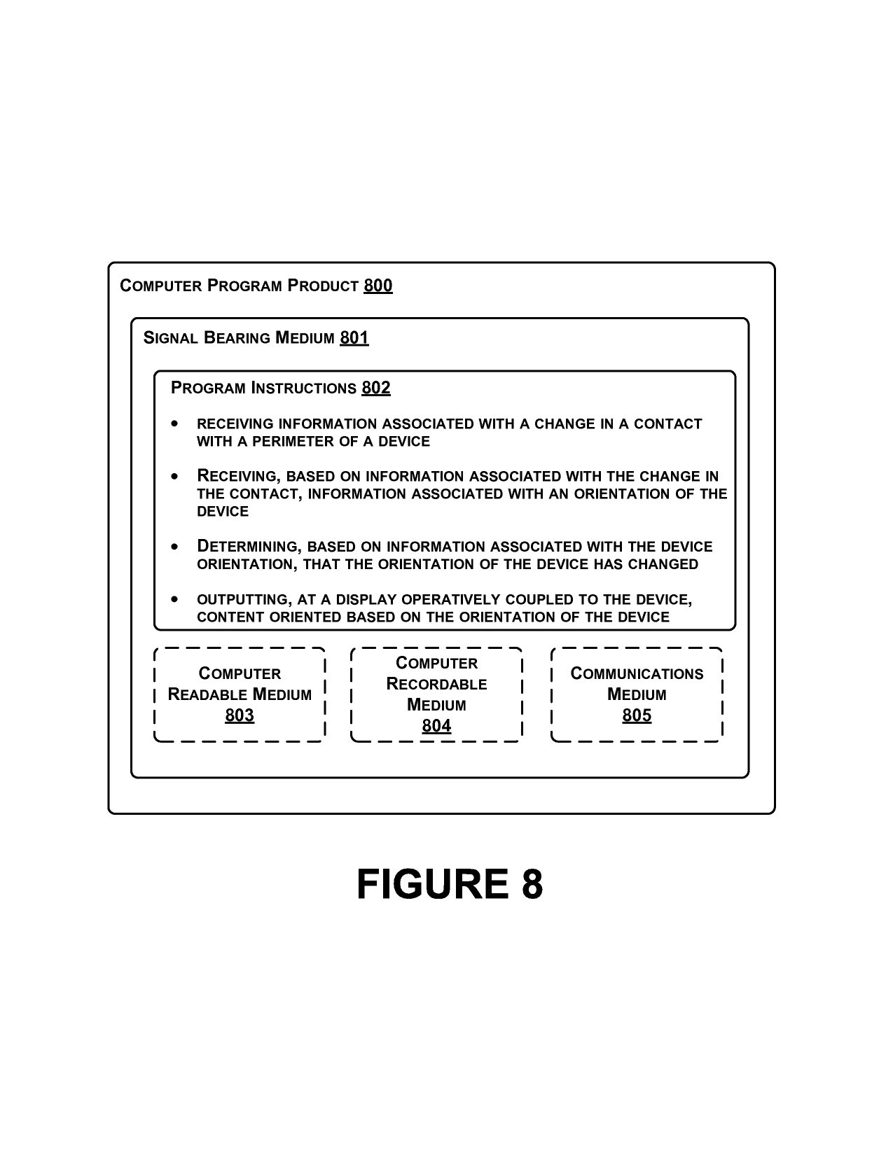

In some embodiments, the disclosed methods may be implemented as computer program instructions encoded on a computer-readable storage media in a machine-readable format, or on other non-transitory media or articles of manufacture. FIG. 8 is a schematic illustrating a conceptual partial view of an example computer program product 800 that includes a computer program for executing a computer process on a computing device, arranged according to at least some embodiments presented herein. In one embodiment, the example computer program product 800 is provided using a signal bearing medium 801. The signal bearing medium 801 may include one or more program instructions 802 that, when executed by one or more processors may provide functionality or portions of the functionality described above with respect to FIGS. 1-7. Thus, for example, referring to the embodiments shown in FIGS. 2 and 6, one or more features of blocks 202-212 and/or blocks 602-612 may be undertaken by one or more instructions associated with the signal bearing medium 801. In addition, the program instructions 802 in FIG. 8 describe example instructions as well.

In some examples, the signal bearing medium 801 may encompass a computer-readable medium 803, such as, but not limited to, a hard disk drive, a Compact Disc (CD), a Digital Video Disk (DVD), a digital tape, memory, etc. In some implementations, the signal bearing medium 801 may encompass a computer recordable medium 804, such as, but not limited to, memory, read/write (R/W) CDs, R/W DVDs, etc. In some implementations, the signal bearing medium 801 may encompass a communications medium 805, such as, but not limited to, a digital and/or an analog communication medium (e.g., a fiber optic cable, a waveguide, a wired communications link, a wireless communication link, etc.). Thus, for example, the signal bearing medium 801 may be conveyed by a wireless form of the communications medium 805 (e.g., a wireless communications medium conforming to the IEEE 802.11 standard or other transmission protocol).

The one or more programming instructions 802 may be, for example, computer executable and/or logic implemented instructions. In some examples, a computing device such as the computing device 700 of FIG. 7 may be configured to provide various operations, functions, or actions in response to the programming instructions 802 conveyed to the computing device 700 by one or more of the computer readable medium 803, the computer recordable medium 804, and/or the communications medium 805.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A method, comprising:
determining, by a processor, that a change in a contact with a perimeter of a device exceeds a predetermined contact change threshold, wherein the change in the contact with the perimeter of the device exceeding the predetermined contact change threshold indicates that a change in orientation of the device may have occurred;
causing, in response to determining that the change in the contact with the perimeter of the device exceeds the predetermined contact change threshold, a sensor coupled to the device to switch from a disabled state to an enabled state, wherein the processor is configured to receive, while the sensor is in the enabled state, information associated with a current orientation of the device;
receiving the information associated with the current orientation of the device;
outputting, at a display operatively coupled to the device, content oriented based on the current orientation of the device; and
causing the sensor to switch back to the disabled state.

2. The method of claim 1, wherein determining that the change in the contact with the perimeter of the device exceeds the predetermined contact change threshold comprises receiving information associated with a capacitance associated with a housing of the device.

3. The method of claim 1, wherein determining that the change in the contact with the perimeter of the device exceeds the predetermined contact change threshold comprises receiving information associated with a resistance associated with a housing of the device.

4. The method of claim 1, wherein determining that the change in the contact with the perimeter of the device exceeds the predetermined contact change threshold comprises receiving information associated with a tactile sensor coupled to a housing of the device.

5. The method of claim 1, wherein determining that the change in the contact with the perimeter of the device exceeds the predetermined contact change threshold comprises receiving information associated with a tactile sensor, wherein a housing of the device includes the tactile sensor.

6. The method of claim 1, wherein determining that the change in the contact with the perimeter of the device exceeds the predetermined contact change threshold comprises receiving information associated with a grip pressure on the device.

7. The method of claim 1, wherein determining that the change in the contact with the perimeter of the device exceeds the predetermined contact change threshold comprises receiving information associated with a thermal distribution on the device.

8. The method of claim 1, wherein determining that the change in the contact with the perimeter of the device exceeds the predetermined contact change threshold comprises receiving information associated with a proximity sensor coupled to the device.

9.-10. (canceled)

11. The method of claim 1, further comprising:
continuously receiving information associated with the contact with the perimeter of the device; and
determining that the change in the contact with the perimeter of the device has occurred.

12. A non-transitory computer readable medium having stored thereon instructions executable by a computing device to cause the computing device to:
determine that a change in a contact with a perimeter of a device exceeds a predetermined contact change threshold, wherein the change in the contact with the perimeter of the device exceeding the predetermined contact change threshold indicates that a change in orientation of the device may have occurred;
cause, in response to determining that the change in the contact with the perimeter of the device exceeds the predetermined contact change threshold, a sensor coupled to the device to switch from a disabled state to an enabled state, wherein the computing device is configured to receive, while the sensor is in the enabled state, information associated with a current orientation of the device;
receive the information associated with the current orientation of the device;
output, at a display operatively coupled to the device, content oriented based on the current orientation of the device; and
cause the sensor to switch back to the disabled state.

13. The non-transitory computer readable medium of claim 12, wherein the instructions executable by the computing device further comprise instructions to cause the computing device to receive given information indicating the change in the contact, wherein the given information is indicative of at least one of the following:
a capacitance associated with a housing of the device;
a resistance associated with the housing of the device;
a tactile sensor coupled to the housing of the device;
a grip pressure on the device;
a thermal distribution on the device; and
a proximity sensor coupled to the device.

14. The non-transitory computer readable medium of claim 12, wherein the instructions executable by the computing device further comprise instructions to cause the computing device to:
continuously receive information associated with the contact with the perimeter of the device; and
determine that the change in the contact with the perimeter of the device has occurred.

15. (canceled)

16. A device, comprising:
a processor;
a sensor;
a display; and
a memory, the memory storing instructions to cause the processor to:
determine that a change in a contact with a perimeter of the device exceeds a predetermined contact change threshold, wherein the change in the contact with the perimeter of the device exceeding the predetermined contact change threshold indicates that a change in orientation of the device may have occurred;
cause, in response to determining that the change in the contact with the perimeter of the device exceeds the predetermined contact change threshold, the sensor to switch from a disabled state to an enabled state, wherein the processor is configured to receive, while the sensor is in the enabled state, information associated with a current orientation of the device;
receive the information associated with the current orientation of the device;
output, at a display operatively coupled to the device, content oriented based on the current orientation of the device; and
cause the sensor to switch back to the disabled state.

17. The device of claim 16, wherein the instructions further cause the processor to receive given information indicating the change in the contact, wherein the given information is indicative of at least one of the following:
a capacitance associated with a housing of the device;
a resistance associated with the housing of the device;
a tactile sensor coupled to the housing of the device;
a grip pressure on the device;
a thermal distribution on the device; and
a proximity sensor coupled to the device.

18.-19. (canceled)

20. The device of claim 16, wherein the instructions further cause the processor to:
continuously receive information associated with the contact with the perimeter of the device; and
determine that the change in the contact with the perimeter of the device has occurred.
